(19) United States
(12) Patent Application Publication
(10) Pub. No.: US 2011/0083875 A1
(43) Pub. Date: Apr. 14, 2011

(54) Exterior utility guard

(76) Inventors: Christopher A. Bailey, McKinney, TX (US); Harvey W. Graham, McKinney, TX (US)

(21) Appl. No.: 12/661,268

(22) Filed: Mar. 15, 2010

Related U.S. Application Data
(60) Provisional application No. 61/166,748, filed on Apr. 5, 2009.

(51) Int. Cl. H02G 3/04

(52) U.S. Cl. 174/68.3

(57) ABSTRACT

An EXTERIOR UTILITY GUARD that is a protector and or shield for low voltage irrigation wire and more particularly to protect the wires from lawn equipment, particularly weed and grass trimmers. It is made of heavy gauge metal, 14 gauge steel, to withstand repeated blows from weed and grass trimmers. It is long enough (16″ + or −) to extend both into and above ground level to protect the low voltage wires from the strike zone of weed and grass trimmers. It is designed with three elongated slots at the bottom to accommodate low voltage wires. It has four holes at the top sides to accommodate a mounting bracket. It is designed so it can be mounted over the irrigation wires and or PCV pipe without having to disconnect the wires from the control box. This design will reduce installation labor and cost.

### BACKGROUND AND FIELD OF THE INVENTION

The present invention relates generally to a protector and or shield for low voltage irrigation wire and more particularly to protect the wires from lawn equipment, particularly weed and grass trimmers.

There are many types of wire protecting devices on the market to protect electric, phone, alarm and other types of wire from vandalism, tampering and concealed in wall damage. This invention protects low voltage irrigation wire from lawn equipment where underground utilities meet the foundation and wall.

Generally low voltage sprinkler wires run from a control box in the garage or house. They generally run through an outside wall and down the exterior of the wall into the ground where they continue underground to numerous control valves.

Generally the low voltage wires run down the exterior wall and into the ground incased in PVC pipe. After time the PVC pipe breaks down from a combination of UV rays from the sun and repeated impact from lawn equipment particularly, weed and grass trimmers.

Once the PVC pipe is fractured the low voltage irrigation wires are exposed and become damaged.

This device, the EXTERIOR UTILITY GUARD is designed to slip over the PVC pipe, either before or after it is fractured. This prevents any additional damage to the low voltage irrigation wires that run through the PVC pipe.

### DESCRIPTION OF DRAWING

Referring to the sole drawing of the EXTERIOR UTILITY GUARD. The preferred embodiment 1 in FIG. 3 is made of heavy gauge metal, fourteen gauge steel, aluminum, polycarbonate, etc. to withstand repeated blows from weed and grass trimmers.

It is long enough 16″ + or − to extend both into and above ground level to protect the low voltage wires from the strike zone of weed and grass trimmers. In FIG. 3, 2 would extend above the ground and 3 is installed below ground.

It is designed that open side 4 in FIG. 2 and FIG. 3 fits over and protects exposed wires or various sized PVC pipe. The most common sizes used in residential installations are ½″, ¾″ and 1″.

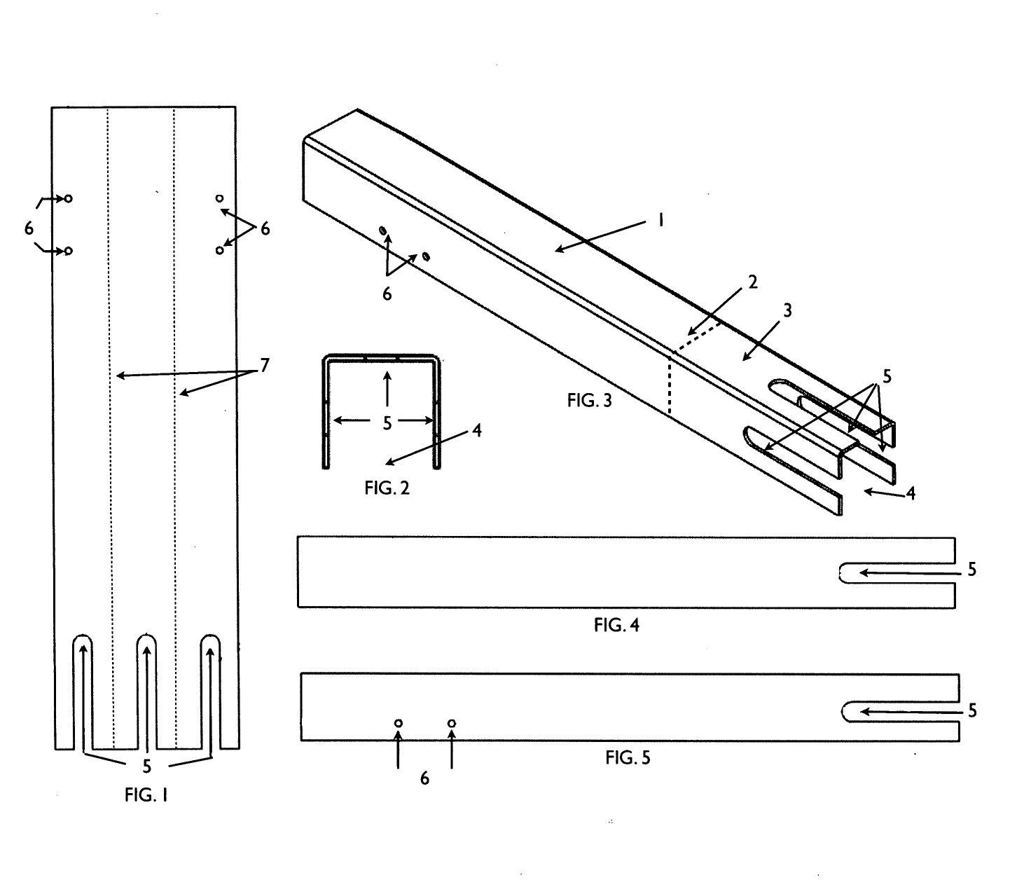

Slots 5 three of them in FIG. 1, FIG. 2, FIG. 3, FIG. 4, and FIG. 5, one on the front and one on each of two sides are ½″×3″ to accommodate the low voltage wires that extend into the ground and veer off in various directions on their way to the control valves.

Holes 6 near the top of each side, two on each side in FIG. 1, FIG. 3 and FIG. 5 are to accommodate a mounting bracket to secure the EXTERIOR UTILITY GUARD to the outside wall when necessary. Some applications may require mounting while in some circumstances in-ground installation may be adequate.

The EXTERIOR UTILITY GUARD is designed that open side 4 in FIG. 2 and FIG. 3 can be mounted over the irrigation wires and or PCV pipe without having to disconnect the wires from the control box. This design will reduce installation labor and cost.

Lines 7 in in FIG. 1 represent where the embodiment would be folded when manufactured from sheet steel however the embodiment could also be extruded.

The design of the EXTERIOR UTILITY GUARD is such that its use could be expanded to protect numerous other low voltage wires, cables, conduits or tubes carrying signal, low voltage, phone, computer or internet wire. PVC and copper water lines could be similarly protected.

The design of the EXTERIOR UTILITY GUARD is such that its design could be manufactured and offered in various sizes depending on the application and whether it is residential or commercial.

The design of the EXTERIOR UTILITY GUARD is such that its design could be manufactured and offered in various materials such as steel, aluminum, polycarbonate, etc.

The design of the EXTERIOR UTILITY GUARD is such that it can protect not only from weed and grass trimmers but also numerous types of equipment and situations.

1. (A) Our claim is that there is not an EXTERIOR UTILITY GUARD to protect and or shield low voltage irrigation wire or its conduit and more particularly to protect the wires from lawn equipment, especially weed and grass trimmers. This makes its design unique.
(B) Our EXTERIOR UTILITY GUARD is designed to be mounted over the irrigation wires and or conduit without having to disconnect the wires from the control box and extends below ground to protect the low voltage wires from the strike zone of weed and grass trimmers. This design will reduce installation labor and cost. This makes its design unique.
(C) Our EXTERIOR UTILITY GUARD is designed so it can be mounted to the wall or be free standing. It is made of heavy gauge metal, fourteen gauge steel, to withstand repeated blows from weed and grass trimmers. This makes its design unique. The detailed description field of this application describes in detail; the design, function and application of our invention.
